(19) United States
(12) Patent Application Publication
(10) Pub. No.: US 2012/0071578 A1
(43) Pub. Date: Mar. 22, 2012

(54) PRODUCING MELAMINE-FORMALDEHYDE FOAMS

(75) Inventors: HORST BAUMGARTL, Mainz (DE); Bettina Wester, Maxdorf (DE); Jens-Uwe Schierholz, Bensheim (DE)

(73) Assignee: BASF SE, Ludwigshafen (DE)

(21) Appl. No.: 13/233,499

(22) Filed: Sep. 15, 2011

Related U.S. Application Data
(60) Provisional application No. 61/383,339, filed on Sep. 16, 2010.

(51) Int. Cl. C08J 9/36; C08J 9/06; B24D 3/00; C08G 12/32

(52) U.S. Cl. 521/188; 264/54; 51/296

(57) ABSTRACT

The invention relates to processes for producing a melamine-formaldehyde foam comprising the consecutive steps a) and b):

a) heating a mixture comprising a melamine-formaldehyde precondensate, a curative and a blowing agent to foam up and crosslink said mixture, and

b) tempering the foam obtained in step a),

wherein it is essential to the present invention that

step a) utilizes a precondensate which has a melamine:formaldehyde molar ratio in the range from 1:2,1 to 1:3.9, and

which has a sulfite group content, based on the total weight of the melamine-formaldehyde precondensate, in the range from 0% to 1% by weight, and

said tempering in step b) is effected at a temperature in the range from 230 to 290° C.,

and also to melamine-formaldehyde foams obtainable according to the processes of the invention, and to uses thereof.

### DESCRIPTION

The present invention relates to processes for producing a melamine-formaldehyde foam comprising the consecutive steps a) and b):

a) heating a mixture comprising a melamine-formaldehyde precondensate, a curative and a blowing agent to foam up and crosslink said mixture, and

b) tempering the foam obtained in step a).

The present invention further relates to melamine-formaldehyde foams and to their use.

Open-cell resilient foams based on melamine-formaldehyde resins and also processes for producing them by using hot air, steam or microwave irradiation to foam up and crosslink a blowing agent-containing solution or dispersion of a melamine-formaldehyde precondensate followed by a tempering step are known and are described for example in EP-A 74 593, EP-A 17 671, EP-A 17 672 and EP-A 37 470.

Foams based on formaldehyde resins regrettably emit small quantities of formaldehyde. Formaldehyde emission increases with increasing temperature and humidity/moisture.

Formaldehyde emissions by melamine-formaldehyde foams are reducible according to WO 06/134083 for example by incorporating specific formaldehyde scavengers, urea for example, during the foaming and crosslinking step of the foam production process. However, these scavengers lose their efficacy at high temperatures and they adversely affect other properties of the foamed material. It is accordingly an in-principle desire to avoid the use of additional substances in the course of the manufacture of melamine-formaldehyde foams in order that undesirable influences on the foaming process and/or the properties of the foamed material may be foreclosed.

WO 01/94436 accordingly describes processes for producing melamine-formaldehyde foams having low formaldehyde emission which each utilize a melamine-formaldehyde precondensate having a melamine-to-formaldehyde molar ratio of greater than 1:2 and more particularly in the range from 1:1 to 1:1.9, this precondensate preferably being free of sulfite groups. Although these melamine-formaldehyde foams having such low formaldehyde contents do generally give very low formaldehyde emissions after 30 minutes' tempering at 220° C., their mechanical properties (tensile strength, breaking strength) are in need of improvement.

Melamine-formaldehyde foams having higher formaldehyde contents than 1:2 (melamine:formaldehyde molar ratio of precondensate used) do have distinctly better mechanical properties, but their formaldehyde emissions increase appreciably with increasing formaldehyde content of the precondensate and, more particularly, sulfite-modified resins lack the desired stability to hydrolysis in a warm and moist environment. This lack of stability leads to an undesirable, appreciable increase in formaldehyde release at elevated temperatures and humidities. A further disadvantage of these foams is their tendency to yellow at elevated tempering temperatures.

It is an object of the present invention to provide processes for producing melamine-formaldehyde foams which give rise to very low formaldehyde emissions under warm and moist conditions but at the same time have good mechanical properties and ideally display no yellowing effects.

We have found that this object is achieved by the initially mentioned processes for producing melamine-formaldehyde foams wherein it is essential to the present invention that

step a) utilizes a precondensate which has a melamine:formaldehyde molar ratio in the range from 1:2.1 to 1:3.9, and

which has a sulfite group content, based on the total weight of the melamine-formaldehyde precondensate, in the range from 0% to 1% by weight, and

said tempering in step b) is effected at a temperature in the range from 230 to 290° C.

The present invention further provides melamine-formaldehyde foams obtainable according to the processes of the present invention and also uses thereof.

The melamine-formaldehyde foams obtainable according to the processes of the present invention give rise to but minimal formaldehyde emissions even under warm and moist conditions, have good mechanical properties and display no yellowing effects.

The processes, articles and uses of the present invention will now be described.

The present invention processes for producing melamine-formaldehyde foams comprise the successive steps a) and b):

a) heating a mixture comprising a melamine-formaldehyde precondensate, a curative and a blowing agent to foam up and crosslink said mixture, and

b) tempering the foam obtained in step a),

which process steps as well as the melamine-formaldehyde precondensates, curatives and blowing agents useful in step a) are known in principle to a person skilled in the art and are described in the literature (see for example the references cited at the beginning).

It is essential to the present invention that

step a) utilizes a precondensate which has a melamine:formaldehyde molar ratio in the range from 1:2.1 to 1:3.9 and preferably in the range from 1:2.5 to 1:3.5 and

which has a sulfite group content, based on the total weight of the melamine-formaldehyde precondensate, in the range from 0% to 1% by weight, preferably in the range from 0% to 0.1% by weight and more preferably 0% by weight.

The melamine-formaldehyde precondensate in addition to melamine and formaldehyde may comprise up to 50% by weight and preferably up to 20% by weight (all based on the weight of cocondensed melamine) of other thermoset-formers and up to 50% by weight and preferably up to 20% by weight (all based on the weight of cocondensed formaldehyde) of other aldehydes in cocondensed form. Useful thermoset formers include for example: alkyl- and aryl-alkyl-substituted melamine, urea, urethanes, carboxamides, dicyandiamide, guanidine, sulfurylamide, sulfonamides, aliphatic amines, glycols, phenol and its derivatives. Examples of useful other aldehydes are acetaldehyde, trimethylolacetaldehyde, acrolein, benzaldehyde, furfurol, glyoxal, glutaraldehyde, phthalaldehyde and terephthalaldehyde. Particular preference is given to an unmodified melamine-formaldehyde precondensate, i.e., a melamine-formaldehyde precondensate devoid of any other thermoset formers or other aldehydes. Further details concerning melamine-formaldehyde condensation products may be found in Houben-Weyl, Methoden der organischen Chemie, volume 14/2, 1963, pages 319 to 402.

Commercially available melamine-formaldehyde precondensates are useful for a multiplicity of fields of use, for example for further processing into glues. Melamine formaldehyde precondensates comprising sulfite groups are advantageous for use in some of these fields. Such sulfite group-containing melamine-formaldehyde precondensates are obtainable for example as described in EP-B 37470 whereby from 1% to 20% by weight of sodium disulfite is incorporated in the course of the condensation of melamine and formaldehyde to obtain cocondensed sulfite groups.

For the processes of the present invention, however, it is essential that step a) utilizes a precondensate which combines the abovementioned essential melamine:formaldehyde molar ratio with the abovementioned essential sulfite group contents.

Emulsification of the blowing agent and stabilization of the foam in step a) requires the addition of an emulsifier or emulsifier mixture. Useful emulsifiers include anionic, cationic and nonionic surfactants and also mixtures thereof.

Suitable anionic surfactants are diphenylene oxide sulfonates, alkane- and alkylbenzenesulfonates, alkylnaphthalenesulfonates, olefinsulfonates, alkyl ether sulfonates, fatty alcohol sulfates, ether sulfates, alpha-sulfo fatty acid esters, acylaminoalkanesulfonates, acyl isethionates, alkyl ether carboxylates, N-acylsarcosinates, alkyl and alkyl ether phosphates. Useful nonionic surfactants include alkylphenol polyglycol ethers, fatty alcohol polyglycol ethers, fatty acid polyglycol ethers, fatty acid alkanolamides, EO-PO block copolymers, amine oxides, glycerol fatty acid esters, sorbitan esters and alkylpolyglucosides. Useful cationic emulsifiers include alkyltriammonium salts, alkylbenzyldimethylammonium salts and alkylpyridinium salts. The emulsifiers are preferably added in amounts of 0.2% to 5% by weight, based on the melamine-formaldehyde precondensate.

For the melamine-formaldehyde precondensate, which is preferably used in the form of an aqueous solution or dispersion, to produce a foam in step a), it has to comprise a blowing agent, the amount depending on the desired density of the foam. In principle, the process of the present invention can utilize both physical blowing agents and chemical blowing agents. Useful physical blowing agents include, for example, hydrocarbons, halogenated and more particularly fluorinated hydrocarbons, alcohols, ethers, ketones and esters in liquid form or air and CO₂ as gases. Useful chemical blowing agents include, for example, isocyanates mixed with water, in which case CO₂ is released as an effective blowing agent, moreover carbonates and bicarbonates mixed with acids, which likewise produce CO_{2,} and also azo compounds, such as azodicarbonamide. In one preferred embodiment of the present invention, the aqueous solution or dispersion of the melamine-formaldehyde precondensate is admixed with between 1% and 40% by weight, based on the melamine-formaldehyde precondensate, of a physical blowing agent having a boiling point of between 0 and 800C; in the case of pentane, the amount used is preferably in the range from 5% to 15% by weight.

Curatives used in step a) comprise acidic compounds catalyzing the continued condensation of the melamine-formaldehyde precondensate. The amounts are between 0.01% and 20% by weight and preferably between 0.05% and 5% by weight, based on the melamine-formaldehyde precondensate. Organic and inorganic acids can be used, examples being hydrochloric acid, sulfuric acid, phosphoric acid, nitric acid, formic acid, acetic acid, oxalic acid, toluenesulfonic acids, amidosulfonic acids and also acid anhydrides.

The aqueous solution or dispersion of the melamine-formaldehyde precondensate used in step a) is preferably free of further added substances. However, it can be beneficial for some purposes to add up to 20% by weight, and preferably less than 10% by weight, based on the melamine-formaldehyde precondensate, of customary added substances, such as dyes, flame retardants, UV stabilizers, agents to lower combustion gas toxicity or to promote carbonization. Since the foams are generally open celled and capable of imbibing water, some applications make it necessary to add hydrophobicizers in amounts of 0.2% to 5% by weight. Useful hydrophobicizers include for example silicones, paraffins, silicone surfactants, fluorosurfactants, hydrophobic hydrocarbonaceous surfactants, silicone emulsions and fluorocarbon emulsions.

The concentration of the melamine-formaldehyde precondensate in the mixture of precondensate and solvent/dispersant, more particularly water, can vary within wide limits between 55% and 85% by weight and preferably between 63% and 80% by weight, all based on the total weight of melamine-formaldehyde precondensate and solvent/dispersant. The preferred viscosity of the mixture of precondensate and solvent/dispersant is between 1 and 3000 dPa.s and preferably between 5 and 2000 dPa.s.

Added substances are mixed with the aqueous solution or dispersion of the melamine-formaldehyde precondensate to form a homogeneous mixture, with the blowing agent being forced in under pressure if necessary. However, it is also possible to start with a solid, for example spray-dried, melamine-formaldehyde precondensate and to mix it with an aqueous solution of the emulsifier, with the curative and also with the blowing agent. After mixing, the heated resin solution with the dispersed blowing agent is discharged through a die and foams up thereafter.

Foaming of the blowing agent-containing solution or dispersion upon emergence from the die is augmented—as described in EP-B 17671—by means of hot air or high frequency radiation. Preferably, the foaming operation is carried out with ultra-high frequency irradiation as described in EP-B 37470. This so-called dielectric heating can in principle employ microwaves in the frequency range from 0.2 GHz to 100 GHz. For industrial operation, frequencies of 0.915, 2.45 and 5.8 GHz are available, among which 2.45 GHz is particularly preferred. Microwaves are produced in a magnetron, although it is generally a plurality of magnetrons which are used at any one time.

Irradiating is advantageously carried out such that the power taken up by the solution or dispersion is between 5 and 200 KW and preferably between 9 and 120 KW, based on 1 kg of water in the solution or dispersion.

The mixture to be blown is irradiated immediately on emerging from the foaming die. The blowing agent evaporates, the resin mixture foams up and at the same time cures through.

It is a further essential feature of the process of the present invention that the foam obtained in step a) is tempered in a subsequent step b) at a temperature in the range from 230 to 290° C., preferably in the range from 240 to 280° C. and more preferably in the range from 250 to 270° C., which very substantially removes the formaldehyde.

In a preferred embodiment of the process of the present invention, the tempering as per step b) is carried with hot air and the duration of the tempering is in the range from 10 to 60 min, preferably in the range from 31 to 50 min and more preferably in the range from 35 to 40 min.

In a further preferred embodiment the process of the present invention, said tempering in step b) is effected by means of hot air at a flow rate in the range from 2000 to 8000 STPm³/m² of foam contact area/h (with STP conditions as per German standard specification DIN 1343).

In a further embodiment of process of the present invention, step b) is followed by a step c) in which the tempered foam is press molded to make it elastic.

Step c) is known in principle to a person skilled in the art and is described in the literature, for example in EP-A 1 505 105 and EP-B 37470.

The melamine-formaldehyde foams obtainable according to the processes of the present invention give rise to a very low formaldehyde emission, particularly under hot and moist conditions. Formaldehyde emissions can be measured in a dynamic testing chamber as per DIN EN 717-1 or in water as per DIN EN 14184-1 and JIS L 1041 or else in a saturated water vapor atmosphere as per VDA 275. The formaldehyde emissions of the foam of the present invention are <0.03 mg of formaldehyde/m³ of chamber air (measured as per DIN EN 717-1), <40 mg of formaldehyde/kg of foam (measured as per DIN EN 14184-1 and JIS L 1041) and <150 mg of formaldehyde/kg of foam (measured as per VDA 275). The foams of the present invention satisfy all the requirements of the Eco-tex standard 100 in class I (products in contact with the skin of babies and toddlers) and class II (products with direct skin contact). They further have good mechanical properties and are free of any yellowing tendency whatsoever. Their density can be set between 4 and 50 g/l and preferably between 4 and 20 g/I, and the tensile strength values for densities between 8 and 11 g/l are above 100 kPa, measured as per DIN EN ISO 1798.

The foams can be produced as sheets or webs up to 1 m in height or as self-supporting foams a few mm in thickness. All desired sheet or foam thicknesses can be cut out of such foam webs. The foams can be laminated on one or both sides with surface layers, for example with paper, paperboard, glass overlay mat, wood, plasterboard, metal sheet or foil, plastics film/sheet, which may also be foamed if desired.

The main field of use for the foams produced according to the present invention is acoustical and/or thermal insulation in aircraft, ship and motor vehicle construction, in mechanical engineering or in building construction, more particularly heat and sound insulation of buildings and part of buildings, more particularly partitions, but also roofs, exteriors, doors and floors, further heat and sound insulation of motor and interior compartments of vehicles and aircraft and also low-temperature insulation, for example of refrigerated warehouses, oil tanks and liquefied gas containers. Further applications are the use as insulating wall cladding and as an insulating and shock-absorbing packaging material. Owing to the substantial hardness of crosslinked melamine resins, the foams can also be used as cleaning means, for example for slightly abrasive cleaning, grinding and polishing sponges. The open-cell structure of the foams additionally permits the imbibition and storage of suitable cleaning, grinding and polishing media in the interior of the foams. Moreover, for specific cleaning tasks, the sponges can be given hydrophobic and oleophobic finishes. Owing to the extremely low formaldehyde emissions, the foams of the present invention can also be used in the hygiene sector, for example in the form of thin webs as a wound dressing or as a constituent of baby diapers, femcare and incontinence products.

The melamine-formaldehyde foams obtainable according to the processes of the present invention differ from known melamine-formaldehyde foams in that they give rise to but minimal formaldehyde emissions even under hot moist conditions, have good mechanical properties and display no yellowing effects.

The examples which follow illustrate the invention.

### EXAMPLES

Materials and examples designated with a preceding “V-” are not in accordance with the present invention, and are for comparison.

### METHODS OF MEASUREMENT

The formaldehyde emissions, the mechanical properties and the yellowing of the melamine-formaldehyde foams were determined according to the following methods:

### Formaldehyde Emissions

DIN EN 717-1 (test chamber at 23 degrees 0/50% r.h.)

DIN EN 14184-1 (sample stored at 40 degrees C/1 h in water)

VDA 275 (sample at 60 degrees C/100% r.h. above water)

### Mechanical Properties

Tensile strength DIN EN ISO 1798

### Yellowing

Yellowing effects discernible on the particular foams were determined visually and always rated by the same person in accordance with the following scheme:

0=no discernible yellowing effects whatsoever

1=slight yellowing effects discernible

2=distinct yellowing effects discernible.

Examples 1 and 4 and comparative examples V-2, V-3 and V-5

In each case, 70 parts by weight of a spray-dried melamine-formaldehyde precondensate (particular melamine:formaldehyde molar ratio and also sulfite group content in % by weight based on the melamine-formaldehyde precondensate: see table 1) were dissolved in 30 parts by weight of water. This mixture was admixed with 3 parts by weight of formic acid, 2 parts by weight of a fatty alcohol polyglycol ether as surfactant and 10 parts by weight of pentane. This mixture was vigorously stirred and subsequently blown in a foaming mold of polypropylene by irradiation with microwave energy at 2.54 GHz.

The foams formed were then each tempered with hot air under the particular conditions mentioned in table 1.

The properties of the tempered foams obtained in each case are reproduced in table 1.

TABLE 1
Composition of melamine-formaldehyde precondensates
and tempering conditions and properties of foams

| Example | 1 | V-2 | V-3 | 4 | V-5 |
|---|---|---|---|---|---|
| Melamine-formaldehyde molar ratio | 1:3 | 1:3 | 1:3 | 1:3 | 1:1.6 |
| Sulfite group content [% by weight] | 0 | 2 | 2 | 0 | 0 |
| Tempering temperature [° C.] | 260 | 240 | 260 | 240 | 240 |
| Tempering time [min] | 10 | 10 | 10 | 10 | 10 |
| Hot air flow rate for tempering | 4700 | 4700 | 4700 | 4700 | 4700 |
| [STPm³/m² of foam contact area/h] | | | | | |
| Properties | | | | | |
| FA emission to VDA 275 [mg of FA/kg of foam] | 30 | 380 | 170 | 120 | 50 |
| FA emission to DIN EN 14814-1 [mg of FA/kg of foam] | 12 | 94 | 52 | 32 | 18 |
| FA emission to DIN EN 717-1 [mg of FA/m³ of air] | 0.01 | 0.05 | 0.03 | 0.02 | 0.01 |
| Yellowing | 0 | 1 | 2 | 0 | 0 |
| Tensile strength to DIN EN ISO 1798 [kPa] | 120 | 130 | 110 | 130 | 60 |

(preceding V: for comparison, “FA” denotes formaldehyde)

The examples show that the melamine-formaldehyde foams obtainable according to the processes of the present invention differ from known melamine-formaldehyde foams in that they give rise to but minimal formaldehyde emissions even under hot moist conditions, have good mechanical properties and display no yellowing effects.

1-8. (canceled)

9. A process for producing a melamine-formaldehyde foam comprising:
a) heating a mixture comprising a melamine-formaldehyde precondensate, a curative and a blowing agent to foam up and crosslink said mixture, and
b) tempering the foam obtained in step a),
wherein
step a) utilizes a precondensate which has a melamine:formaldehyde molar ratio in the range from 1:2.1 to 1:3.9, and
which has a sulfite group content, based on the total weight of the melamine-formaldehyde precondensate, in the range from 0% to 1% by weight, and
said tempering in step b) is effected at a temperature in the range from 230 to 290° C.

10. The process according to claim 9 wherein the duration of said tempering in step b) is in the range from 10 to 60 min.

11. The process according to claim 9 wherein said tempering in step b) is effected by means of hot air at a flow rate in the range from 2000 to 8000 STPm³/m² of foam contact area/h (with STP conditions as per German standard specification DIN 1343).

12. The process according to claim 9 wherein step b) is followed by a step c) in which the tempered foam is press molded.

13. A melamine-formaldehyde foam obtainable by processes according to claim 9.

14. The melamine-formaldehyde foam according to claim 13, having improved stability to hydrolysis and even at elevated temperature and humidity having very low formaldehyde emissions of
<150 mg of formaldehyde/kg of melamine-formaldehyde foam, measured to VDA 275, and
<40 mg of formaldehyde/kg of melamine-formaldehyde foam, measured to DIN EN 14184-1 and JIS L 1041, and
<0.03 mg of formaldehyde/m³ of chamber air, measured to DIN EN 717-1.

15. The melamine-formaldehyde foam according to claim 13, conforming to the requirements of Eco-Tex standard 100 in classes I and II.

16. The use of the melamine-formaldehyde foam according to claim 13 for acoustical and/or thermal insulation in aircraft, ship and motor vehicle construction, in mechanical engineering or in building construction and also as cleaning means, more particularly as an abrasive cleaning sponge for cleaning surfaces of any kind.
